(19) United States
(12) Patent Application Publication
(10) Pub. No.: US 2018/0000694 A1
(43) Pub. Date: Jan. 4, 2018

(54) ENTERAL SYRINGE HAVING ANGLED CONNECTOR OR BODY HAVING A MINIMUM DIMENSION

(71) Applicant: NEOMED, INC., Woodstock, GA (US)

(72) Inventors: Benjamin M. DAVIS, Woodstock, GA (US); Mark M. COSTELLO, Co. Mayo (IE)

(73) Assignee: NEOMED, INC., Woodstock, GA (US)

(21) Appl. No.: 15/709,280

(22) Filed: Sep. 19, 2017

Related U.S. Application Data
(63) Continuation-in-part of application No. 15/210,282, filed on Jul. 14, 2016.
(60) Provisional application No. 62/396,491, filed on Sep. 19, 2016.
(60) Provisional application No. 62/519,720, filed on Jun. 14, 2017.
(60) Provisional application No. 62/192,454, filed on Jul. 14, 2015.
(60) Provisional application No. 62/207,120, filed on Aug. 19, 2015.
(60) Provisional application No. 62/350,934, filed on Jun. 16, 2016.

(51) Int. Cl. A61J 15/00; A61J 7/00

(52) U.S. Cl. CPC A61J 15/0026; A61J 7/0053

(57) ABSTRACT

An enteral and oral syringe including a syringe barrel and an enteral dosing control coupling and wherein the syringe barrel or other portions thereof define a side-to-side dimension of at least about 13.3 millimeters. In one example form, the coupling is angled with respect to the extension of the syringe body to define a side-to-side dimension of at least about 13.3 millimeters. In another example form, the syringe body includes a desirable cross-sectional shape wherein at least two generally opposite outer periphery portions thereof define a dimension therebetween of at least about 13.3 millimeters.

### CROSS-REFERENCE TO RELATED APPLICATIONS

This application claims the priority benefit of U.S. Provisional Patent Application Ser. No. 62/396,491 filed Sep. 19, 2016 and U.S. Provisional Patent Application Ser. No. 62/519,720 filed Jun. 14, 2017, and is a continuation-in-part of U.S. Non-Provisional patent application Ser. No. 15/210,282 filed Jul. 14, 2016, which claims the priority benefit of U.S. Provisional Patent Application Ser. No. 62/192,454 filed Jul. 14, 2015, U.S. Provisional Patent Application Ser. No. 62/207,120 filed Aug. 19, 2015 and U.S. Provisional Patent Application Ser. No. 62/350,934 filed Jun. 16, 2016, all of which are hereby incorporated herein by reference in their entireties.

### TECHNICAL FIELD

The present invention relates generally to the field of containment, storage and delivery of fluids, and more particularly to a syringe having an angled connector or body having a minimum dimension.

### BACKGROUND

Healthcare patients and neonates are commonly administered fluids such as medication and nutrients through the use of enteral fluid delivery syringes and other enteral fluid transfer and delivery devices. New design and dimensional standards of the International Organization for Standardization (ISO) specify dimensions and requirements for the design and functional performance of small-bore connectors intended to be used for connections on enteral medical devices and accessories. In particular, ISO 80369-3 design standard provides guidance on certain dimensional requirements that are required for enteral syringes and other connectors.

In some applications, for example, when a syringe is used for oral delivery, the dimensional requirements set forth by the ISO 80369-3 design standard pose a potential concern to clinicians and other administrators, for example, that one or more portions of the enteral medical device or syringe could cause trauma or harm to a patient or neonate.

Thus, it can be seen that needs exist for improved enteral and oral fluid delivery syringes and other enteral and oral fluid transfer and delivery devices that pose less of a threat (or no threat) of causing any trauma or harm to a patient while also being compliant or compatible with the ISO standard. It is to the provision of an enteral syringe having an angled connector or a minimum body dimension that the present invention is primarily directed.

### SUMMARY

Example embodiments of the present invention provide an enteral and oral syringe including a syringe barrel and an enteral dosing control coupling. In example embodiments, the syringe can be utilized for both enteral and/or oral delivery. In example embodiments, the syringe barrel or other portions thereof define a side-to-side dimension of at least about 13.3 millimeters.

In one aspect, the present invention relates to an enteral and oral syringe including a hollow cylindrical barrel extending between a proximal end and a distal end, a base flange at a distal end of the barrel, and an enteral dosing control coupling at a proximal end of the barrel. The enteral dosing control coupling is angled relative to the extension of the hollow cylindrical barrel such that a side-to-side dimension of at least about 13.3 millimeters is defined between an outer surface of the barrel and an outermost end of the dosing control coupling.

In example embodiments, the dosing control coupling includes a female ISO 80369-3 formatted coupling. In example embodiments, the female ISO 80369-3 formatted coupling includes a cylindrical outer collar defining a hollow internal chamber. According to one example embodiment, the coupling includes a lumen extension tip projecting axially from the barrel and within the internal chamber of the female ISO 80369-3 formatted coupling, wherein the lumen extension tip includes a small diameter lumen extending therethrough and in communication with the hollow cylindrical barrel.

Optionally, a pair of helical coupling lugs project outwardly from an exterior surface of the collar. Optionally, the dosing control coupling can include a male ISO 80369-3 formatted coupling. In example embodiments, the dosing control coupling is angled between about 90-165 degrees relative to the hollow cylindrical barrel. According to one example embodiment, the side-to-side dimension is defined between an outer surface of the barrel and an outermost surface of one of the coupling lugs.

In another aspect, the present invention relates to an enteral and oral syringe including an elongate barrel having a proximal end and a distal end, and a hollow cavity defined therein. The proximal end includes an enteral dosing control coupling and the distal end includes a base flange. In example embodiments, the elongate barrel has a cross-sectional shape defining a side-to-side dimension of at least about 13.3 millimeters.

In example embodiments, the dosing control coupling has a female ISO 80369-3 formatted coupling. According to one example embodiment, the female ISO 80369-3 formatted coupling includes a cylindrical outer collar defining a hollow internal chamber.

According to one example embodiment, the coupling includes a lumen extension tip projecting axially from the barrel and within the internal chamber of the female ISO 80369-3 formatted coupling. In example embodiments, lumen extension tip includes a small diameter lumen extending therethrough and in communication with the hollow cavity of the elongate barrel.

In one example from, the elongate barrel has a diamond-shaped cross-sectional shape and the side-to-side dimension is defined between the outermost peripheral surfaces of the barrel taken along a major axis thereof. In another example form, the elongate barrel has a generally flat and rectangular cross-sectional shape and the side-to-side dimension is defined between the outermost peripheral surfaces of the barrel taken along a major axis thereof. In another example form, the elongate barrel has an elliptical cross-sectional shape and the side-to-side dimension is defined between the outermost peripheral surfaces of the barrel taken along a major axis thereof. In another example form, the elongate barrel has a rectangular cross-sectional shape and the side-to-side dimension is defined between the outermost peripheral surfaces of the barrel taken along a major axis thereof. In another example form, the elongate barrel has a teardrop cross-sectional shape and the side-to-side dimension is defined between the outermost peripheral surfaces of the barrel taken along a major axis thereof.

In another aspect, the present invention relates to an enteral and oral syringe including an elongate cylindrical barrel extending between a proximal end and a distal end and defining a hollow cavity therein, the proximal end having an enteral dosing control coupling and the distal end having a base flange, and wherein the enteral syringe further includes one or more features extending outwardly from the elongate cylindrical barrel such that a side-to-side dimension between the one or more outwardly extending features is at least about 13.3 millimeters.

In one example embodiment, the one or more features include a pair of fins oppositely positioned and outwardly extending from the elongate cylindrical barrel, and wherein the side-to-side dimension defined between the outermost ends of the fins is at least about 13.3 millimeters. In another example embodiment, the one or more features include a removable sleeve member for coupling around the entirety of the elongate cylindrical barrel, and wherein the side-to-side dimension defined between the outermost surfaces of the sleeve is at least about 13.3 millimeters. In example embodiments, the sleeve includes a first part and a second part pivotally coupled together by a living hinge, and wherein end engagement portions of the first and second parts are configured for removable engagement therebetween such that the sleeve can entirely surround the elongate cylindrical barrel and provide at least some interference therewith.

### BRIEF DESCRIPTION OF THE DRAWINGS

FIG. 1 shows a plan view of a known female connector for use with syringes according to the ISO 80369-3 standard.

FIG. 2 shows a plan view of a known enteral syringe having a female connector.

FIG. 3 shows a cross-sectional view of an enteral syringe according to an example embodiment of the present invention, the syringe having a female connector angled with respect to the extension of the syringe.

FIG. 4 shows a plan view of an enteral syringe according to another example embodiment of the present invention, the syringe having a female connector angled with respect to the extension of the syringe.

FIG. 5 shows a plan view of the angled female connectors of FIGS. 3-4, showing a comparison of the angled extensions thereof.

FIG. 6 shows a front perspective view of an enteral syringe according to another example embodiment of the present invention.

FIG. 7 shows a cross-sectional view of the enteral syringe of FIG. 6 taken along line 7-7.

FIG. 8 shows a perspective view of a plunger for use with the enteral syringe of FIG. 7.

FIG. 9 shows a detailed view of a portion of a plunger according to another example embodiment of the present invention.

FIG. 10 shows a perspective view of an enteral syringe according to another example embodiment of the present invention.

FIG. 11 shows a cross-sectional view of the enteral syringe of FIG. 10 taken along line 11-11.

FIG. 12 shows a perspective view of a plunger for use with the enteral syringe of FIG. 10.

FIG. 13 shows a perspective view of an enteral syringe according to another example embodiment of the present invention.

FIG. 14 shows a cross-sectional view of the enteral syringe of FIG. 13 taken along line 13-13.

FIG. 15 shows a perspective view of an enteral syringe according to another example embodiment of the present invention.

FIG. 16 shows a cross-sectional view of the enteral syringe of FIG. 15 taken along line 16-16.

FIG. 17 shows a perspective view of an enteral syringe according to another example embodiment of the present invention.

FIG. 18 shows a cross-sectional view of the enteral syringe of FIG. 17 taken along line 18-18.

FIG. 19 shows a perspective view of an enteral syringe according to another example embodiment of the present invention.

FIG. 20 shows a cross-sectional view of the enteral syringe of FIG. 19 taken along line 20-20.

FIG. 21 shows a perspective view of a plunger for use with the enteral syringe of FIG. 19.

FIG. 22 shows a perspective view of an enteral syringe according to another example embodiment of the present invention.

FIG. 23 shows an end view of the enteral syringe of FIG. 22.

FIG. 24 shows an end view of the enteral syringe of FIG. 22 according to another example embodiment of the present invention.

FIG. 25 shows a perspective view of an enteral syringe according to another example embodiment of the present invention.

FIG. 26 shows a cross-sectional view of the enteral syringe of FIG. 25 taken along line 26-26.

FIG. 27 shows a perspective view of an enteral syringe according to another example embodiment of the present invention, showing a sleeve partially engaged with the enteral syringe.

FIG. 28 shows the enteral syringe of FIG. 27, wherein the sleeve is fully engaged with the enteral syringe.

FIG. 29 shows an end view of the enteral syringe of FIG. 28.

FIG. 30 shows a cross-sectional view of an enteral syringe according to another example embodiment of the present invention.

FIG. 31 shows a perspective view of an enteral syringe according to another example embodiment of the present invention.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

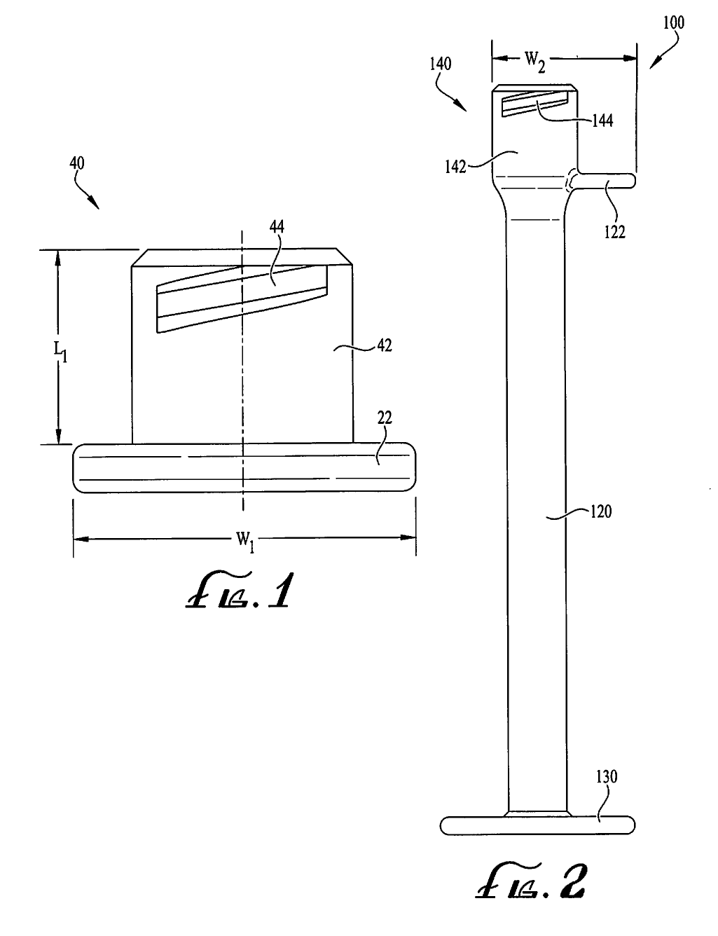

With reference now to the drawing figures, wherein like reference numbers represent corresponding parts throughout the several views, FIG. 1 shows a known enteral dosing control coupling 40 according to the ISO 80369-3 standard. In example embodiments, the dosing control coupling 40 comprises a female ISO 80369-3 formatted coupling substantially conforming to the ISO design standard 80369-3. In example embodiments, the female ISO 80369-3 formatted coupling is engageable with a compatible coupling element such as a corresponding male ISO 80369-3 formatted coupling. In example embodiments, the female ISO 80369-3 formatted coupling 40 generally comprises a base flange 22, a cylindrical collar 42 extending from the base flange 22, and a lumen extending entirely through the coupling 40. Optionally, one or more ribs or lugs 44 are positioned on an outer periphery portion of the cylindrical collar 42. In example embodiments and according to the ISO 80369-3 standard, the base flange 22 comprises a side-to-side dimension or width W₁ of about 13.3 millimeters. According to some example forms, the width W₁ is greater than or equal to about 13.3 millimeters.

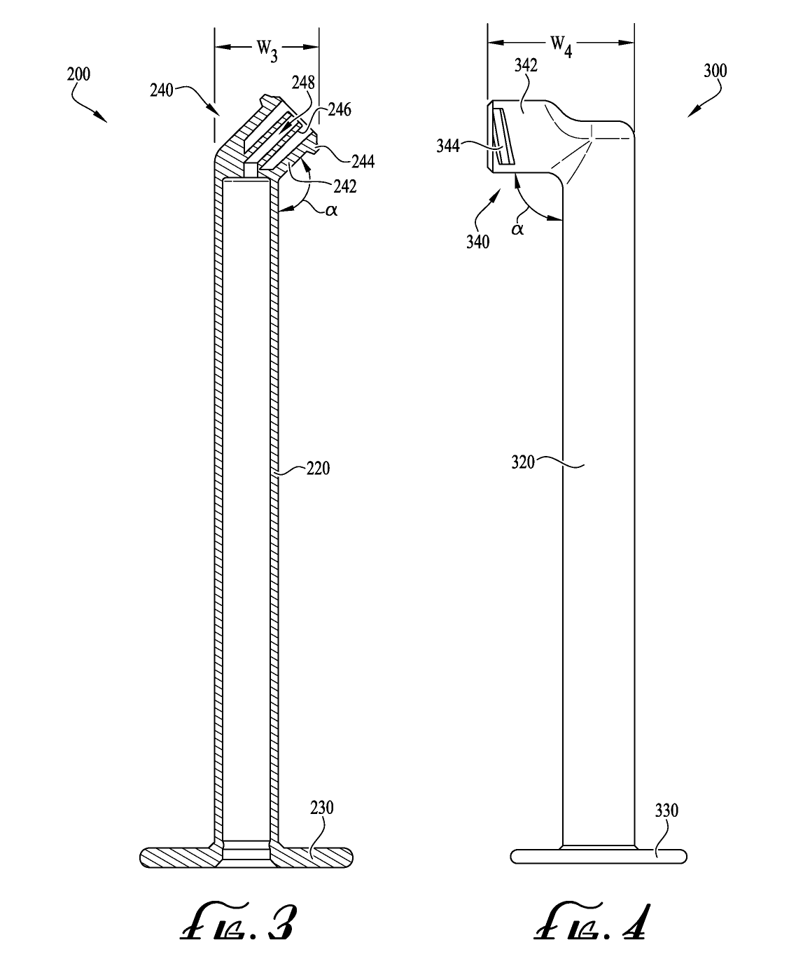

FIG. 2 shows a known enteral syringe 100 comprising a hollow cylindrical barrel 120, a base flange 130 at a distal end of the barrel, and an enteral dosing control coupling 140 at a proximal end of the barrel 120. The enteral dosing control coupling 140 comprises a female ISO 80369-3 formatted coupling, and a tab member 122 generally extends perpendicular relative to the extension of the coupling 140. U.S. Design Patent Application Ser. No. 29/530,724 filed Jun. 8, 2015 is incorporated by reference herein, and shows an enteral syringe having a hollow cylindrical barrel, a base flange at a distal end of the barrel, an enteral dosing control coupling at a proximal end of the barrel, and a tab member extending generally perpendicular therefrom. As per the ISO 80369-3 standard, a side-to-side dimension or width W₂ is defined between an outer periphery portion of the coupling 140 and an end of the tab member 122, which according to the ISO 80369-3 standard, is a minimum of 13.3 millimeters. As such, according to the ISO 80369-3 standard, the syringe comprises a minimum side-to-side dimension W₂ of 13.3 millimeters and is therefore in compliance with the standard.

As described in the ISO 80369-3 standard, when the female connector is used as a source of fluid flow, a ring, wings, or other feature is to be provided behind a thread or rib of the connector, for example, where the minimum dimension between the sides of the connector is 13.3 millimeters. In example embodiments, this minimum dimension standard according to ISO 80369-3 is for the purpose of preventing misconnection with the unspecified inside diameter of most 15 millimeter connectors as defined by ISO 5356-1.

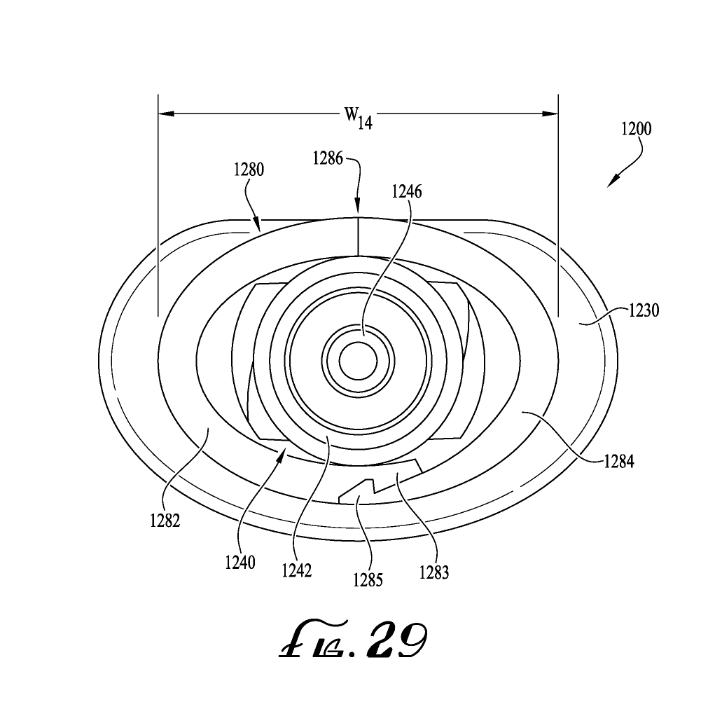

As will be described throughout FIGS. 3-29, the present invention relates to enteral and oral syringes comprising a side-to-side dimension of at least about 13.3 millimeters, for example, to maintain compliance with the ISO 80369-3 standard. In example embodiments, the dosing control couplings thereof, or other features or members of the enteral syringe are configured such that the side-to-side dimension is a minimum of about 13.3 millimeters. According to some example embodiments, the enteral and oral syringes as described herein can comprise a lumen extension tip for substantially improving, if not entirely eliminating dosing inaccuracies. U.S. Non-Provisional patent application Ser. No. 15/210,282 filed Jul. 14, 2016 is incorporated herein by reference in its entirety and shows an enteral syringe having a dosing control coupling comprising a lumen extension tip.

FIG. 3 shows an enteral syringe 200 according to an example embodiment of the present invention. As depicted, the syringe 200 comprises a hollow cylindrical barrel 220, a base flange 230 at a distal end of the barrel, and an enteral dosing control coupling 240 at a proximal end of the barrel 220. In example embodiments, enteral dosing control coupling 240 comprises a female ISO 80369-3 formatted coupling having a cylindrical outer collar 242 defining a hollow internal chamber, and a pair of helical coupling lugs 244 projecting outwardly from the exterior surface of the collar. Optionally, rather than lugs 44 projecting from the exterior surface of the collar, the exterior surface of the collar 42 can comprise helical threads generally extending about at least a portion of the exterior surface thereof, for example, like threads on a bolt, other types of conventional coupling members, etc. In some example embodiments, the exterior surface of the collar is entirely smooth without any lugs, for example, whereby a frictional fit will be provided between the collar 42 and a compatible coupling, for example, a male ISO 80369-3 formatted coupling.

In example embodiments, the coupling 240 further comprises a lumen extension tip 246, projecting axially from the barrel 220 of the syringe into the internal chamber of the collar 242. An internal lumen or enteral fluid delivery conduit 248 extends through the lumen extension tip 246 for fluid communication to and from the contained volume of the barrel 220, allowing fluid delivery in and out of the barrel. The lumen extension tip 246 is generally cylindrical or tubular and includes an internal surface defining the lumen or fluid delivery conduit 248, a cylindrical or slightly tapered external surface, and a distal tip at its free end. The outer coupling collar 242 is also generally cylindrical or tubular, and at least partially surrounding the lumen extension tip 246. The collar 242 comprises an internal surface confronting and spaced a distance apart from the external surface of the lumen extension tip 246, and further comprises an external surface optionally comprising the lugs 244 or other coupling or connection features, and an outer rim at its distal free end. The internal dimension of the collar 242 is greater than the external dimension of the lumen extension tip 246, such that a space therebetween forms a receiver for a cooperating portion of a compatible coupling element (e.g., the male ISO 80369-3 formatted coupling). The lumen extension tip 246 is positioned generally concentrically and coaxially within the collar 242, and the lumen 248 extends generally centrally through the lumen extension tip 246 also concentric and coaxial with the collar.

According to example embodiments, the coupling 240 is preferably angled with respect to the extension of the syringe barrel 220. For example, as depicted in FIG. 3, an angle α is defined between the coupling 240 and the syringe barrel 220 such that a side-to-side dimension or width W₃ is a minimum of about 13.3 millimeters. In example embodiments, the angle α is generally between about 30-179 degrees, for example, between about 90-155 degrees according to one example embodiment of the present invention. Preferably, the side-to-side dimension W₃ is a minimum of about 13.3 millimeters when the coupling 240 is angled relative to the barrel 220 (e.g., defining an included angle α). In example embodiments, the side-to-side dimension W₃ is defined between an outer periphery portion of the syringe barrel and an outer surface of one of the lugs 244. For example, according to one example embodiment, the lugs 244 are oriented in such a manner to contribute to the side-to-side dimension W₃. According to other example embodiments, the lugs 244 can be oriented about the collar 242 as desired, for example, such that the side-to-side dimension W₃ is defined between an outer periphery portion of the syringe barrel 220 and an end portion of the collar 242.

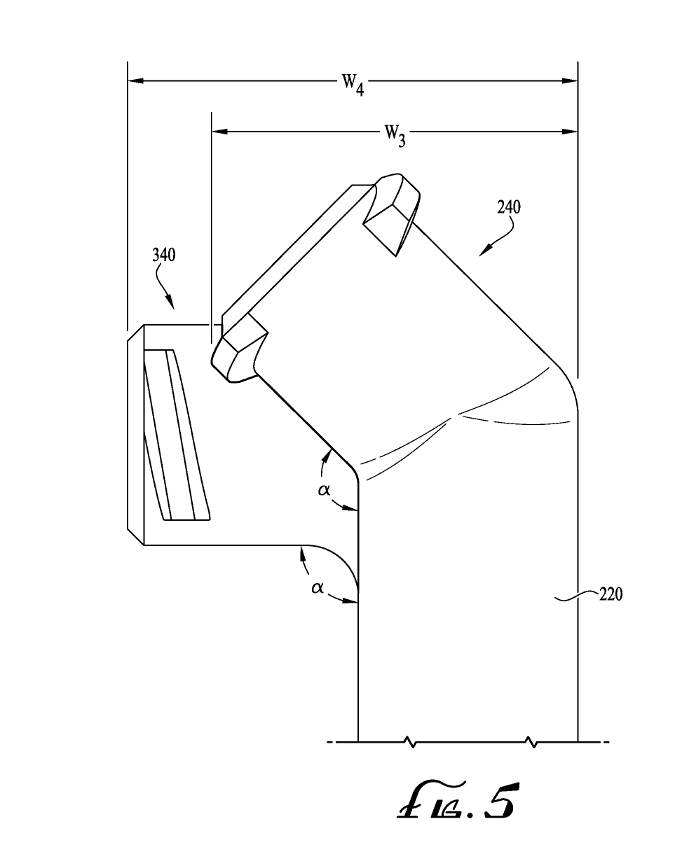

According to one example embodiment, the coupling can be angled at about 90 degrees relative to the syringe barrel. As depicted in FIGS. 4-5, an angle α is defined between the syringe barrel 320 and the coupling 340 such that a side-to-side dimension or width W₄ is defined between the end of the coupling 340 and a generally opposite side of the syringe barrel 320. As depicted in FIG. 5, the extension of the couplings 240, 340 are compared. In example embodiments, both of the side-to-side dimensions W₃, W₄ are at least about 13.3 millimeters and the angle α that defines the extension of the coupling 240 is about 45 degrees. The angle α that defines the extension of the coupling 340 is about 90 degrees. Optionally, any other desirable angle α can be chosen as desired. Furthermore, the coupling can be any desired length, for example, to contribute to the side-to-side dimension thereof. For example, in some example embodiments, the coupling 240 can extend a desired length from the syringe barrel 220. According to one example embodiment, the coupling 240 extends about 4 millimeters greater than the length of extension of the coupling 240. For example, as depicted in FIG. 1 and according to the ISO 83069-3 design standard, the minimum length or extension L₁ of the collar 240 from the base flange 22 is between about 6.90 millimeters to about 11.00 millimeters, for example, to provide clearance for a threaded outer collar of a compatible ISO 80369-3 formatted male connector. Accordingly, the coupling 240 is angled at about 45 degrees relative to the barrel 220 and extends between about 6.90 millimeters to about 11.00 millimeters. Optionally, the coupling 240 can be configured to extend a desired length at any desirable angle, for example, such that a side-to-side dimension thereof is at least about 13.3 millimeters.

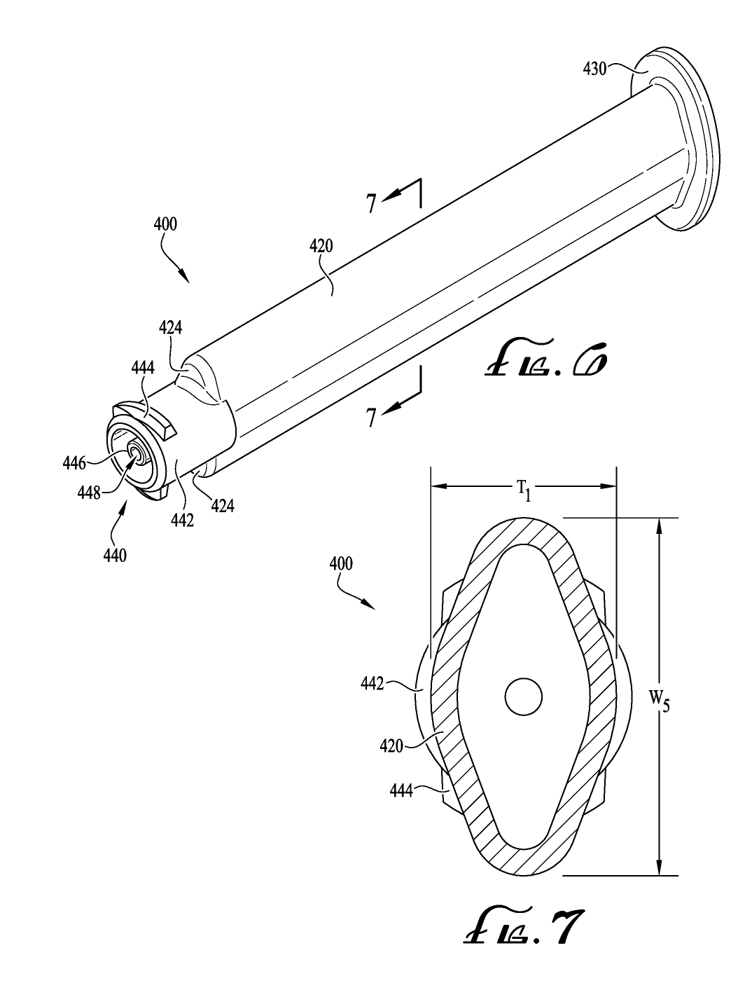

FIG. 6 shows an enteral syringe 400 according to another example embodiment of the present invention. As depicted, the syringe 400 comprises a hollow barrel 420, a base flange 430 at a distal end of the barrel, and an enteral dosing control coupling 440 at a proximal end of the barrel 420. In example embodiments, enteral dosing control coupling 440 comprises a female ISO 80369-3 formatted coupling having a cylindrical outer collar 442 defining a hollow internal chamber, and a pair of helical coupling lugs 444 projecting outwardly from the exterior surface of the collar. Optionally, rather than lugs 444 projecting from the exterior surface of the collar, the exterior surface of the collar 442 can comprise helical threads generally extending about at least a portion of the exterior surface thereof, for example, like threads on a bolt, other types of conventional coupling members, etc. In some example embodiments, the exterior surface of the collar 442 is entirely smooth without any lugs, for example, whereby a frictional fit will be provided between the collar 442 and a compatible coupling, for example, a male ISO 80369-3 formatted coupling. In example embodiments, the coupling 440 further comprises a lumen extension tip 446 comprising a fluid delivery conduit 448 as described above.

In example embodiments, the syringe barrel 420 is generally shaped like a rhombus or is generally diamond-shaped and comprises radiused outer and inner corners or intersections between the four outer and inner sides thereof (see FIG. 7). In example embodiments, the barrel defines a width W₅ and a thickness T₁. In example embodiments, the width W₅ is at least about 13.3 millimeters. The thickness T₁ can be between about 5-12 millimeters, for example about 7 millimeters according to one example embodiment. For example, according to the depicted embodiment of FIG. 7, the cylindrical outer collar 442 comprises an outer diameter that is at least partially greater than the thickness T₁. In example embodiments, the outer diameter of the cylindrical outer collar 442 is about 8 millimeters and the thickness T₁ of the syringe barrel 420 is about 7 millimeters. Optionally, the outer diameter of the cylindrical outer collar 442 can be between about 8.00-8.20 millimeters and the thickness T₁ can be varied as desired, for example, to a dimension less than 8 millimeters or greater than 8.20 millimeters.

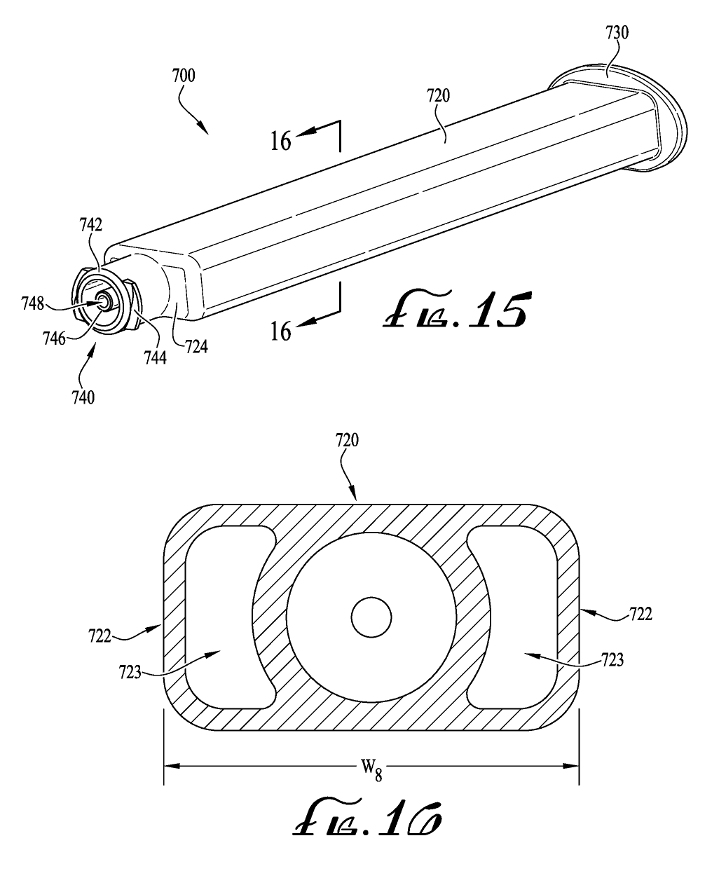

For example, as described above and according to one example embodiment, the outer diameter of the cylindrical outer collar 442 is at least partially greater than the thickness T₁ of the barrel, and as such there is a slight discontinuity along the transition from the outer cylindrical collar to the outer surface of the barrel 420. For example, as will be described in further detail below, the outer diameter of the collar can be substantially similar to the thickness of the barrel, for example, such that a smooth transition is provided therebetween (see FIGS. 13-14). As depicted in FIG. 6, a pair of corner portions 424 are defined at an end portion of the barrel 420 with the coupling 440 positioned between the corner portions (e.g., generally centrally positioned at a central portion of the end portion) and extending therefrom whereby the fluid delivery conduit 448 extends through the lumen extension tip 446 to within the hollow cavity of the barrel 420. In example embodiments, the cylindrical outer collar extends at least about 6.90 millimeters from the corner portions 424. According to one example embodiment, the cylindrical outer collar extends between about 6.90 millimeters to about 11.00 millimeters. According to another example embodiment, the cylindrical outer collar extends about 8.52 millimeters from the corner portions 424. Preferably, the corner portions 424 are substantially rounded and radiused to provide a smooth transition to the outer side surfaces of the barrel 420, for example, to eliminate any concern of scratching or causing trauma to a patient's mouth when the coupling 440 (and in some cases a portion of the syringe body 420) is inserted or removed during oral delivery.

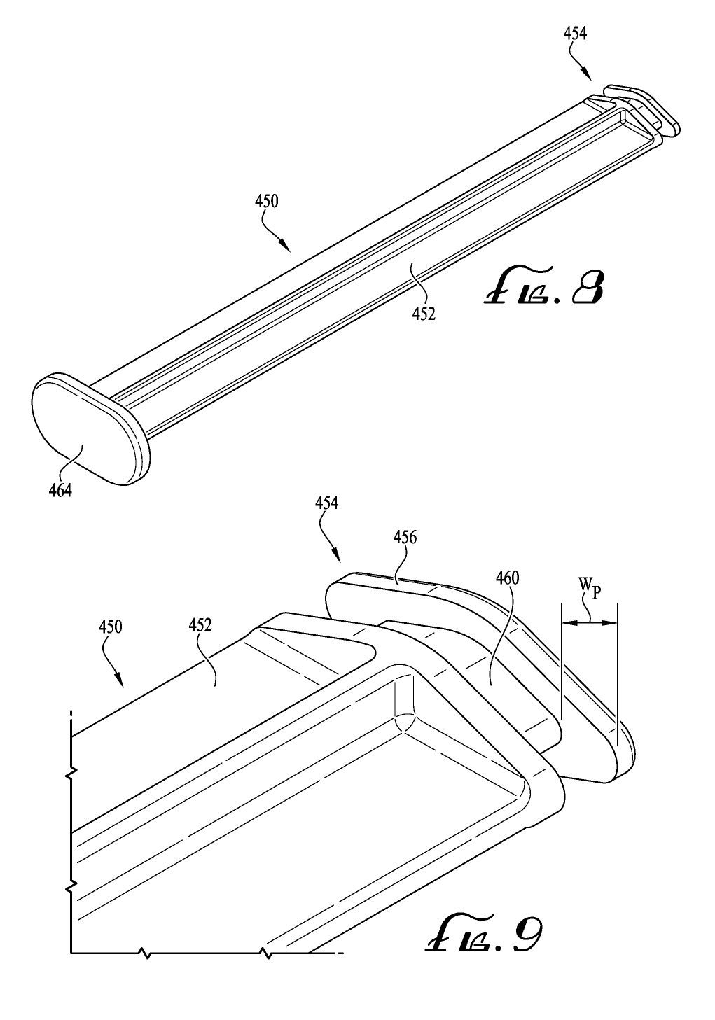

FIGS. 8-9 show a diamond-shaped plunger 450 for compatible insertion within the syringe barrel 420 for dispensing or withdrawing fluids from the syringe 400. In example embodiments, the plunger comprises a generally elongate body 452 comprising a forward end portion 454 defining an end flange 456 and an inset extension portion 460 such that a generally recessed channel or groove is defined therein to provide for compatible fitting engagement with a substantially thick sealing member or gasket. In example forms, a distance W_{P} is defined between an outer surface of the end flange 456 and the inset extension portion 460. According to example embodiments, the distance WP is between about 0.5-3.5 millimeters, for example about 2 millimeters according to one example embodiment. According to some example embodiments, the recessed channel is relatively shallow to provide for compatible engagement with a generally thinner seal or gasket. Optionally, the rearward end of the plunger 450 can comprise an actuating flange or feature 464 for providing manipulation thereof to push or pull the plunger 450 into and out of the hollow barrel 420.

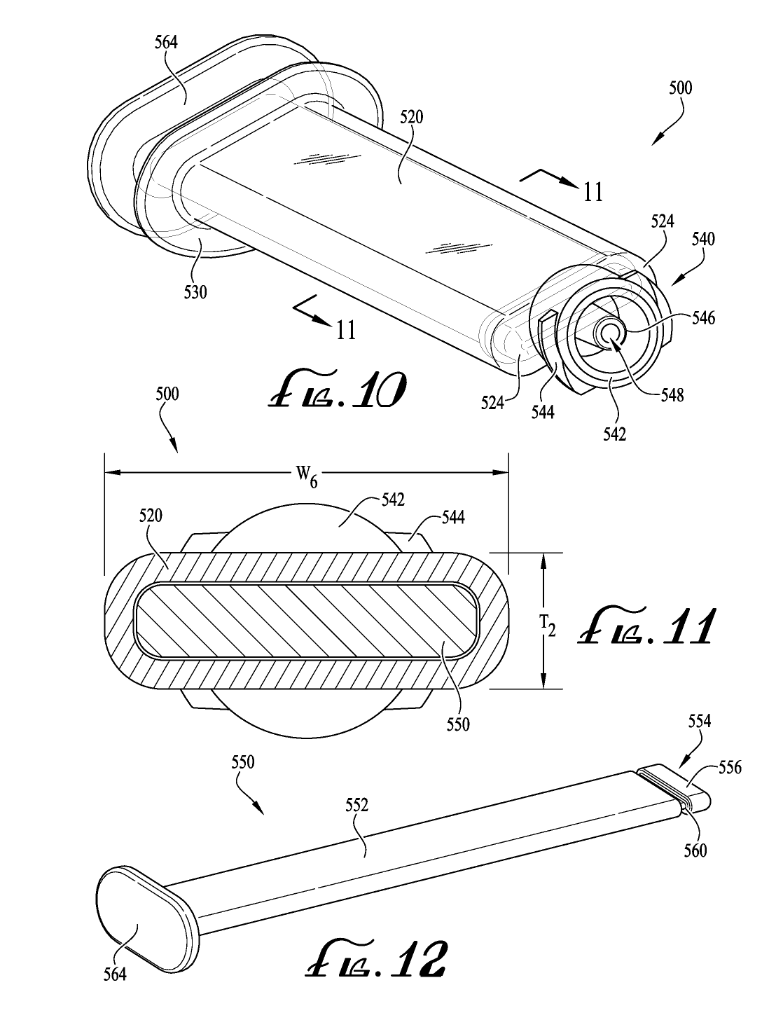

FIG. 10 shows an enteral syringe 500 according to another example embodiment of the present invention. As depicted, the syringe 500 comprises a hollow and generally flat barrel 520, a base flange 530 at a distal end of the barrel 520, and an enteral dosing control coupling 540 at a proximal end of the barrel 520. In example embodiments, enteral dosing control coupling 540 comprises a female ISO 80369-3 formatted coupling having a cylindrical outer collar 542 defining a hollow internal chamber, and a pair of helical coupling lugs 544 projecting outwardly from the exterior surface of the collar. Optionally, rather than lugs 544 projecting from the exterior surface of the collar, the exterior surface of the collar 542 can comprise helical threads generally extending about at least a portion of the exterior surface thereof, for example, like threads on a bolt, other types of conventional coupling members, etc. In some example embodiments, the exterior surface of the collar 542 is entirely smooth without any lugs, for example, whereby a frictional fit will be provided between the collar 542 and a compatible coupling, for example, a male ISO 80369-3 formatted coupling. In example embodiments, the coupling 540 further comprises a lumen extension tip 546 comprising a fluid delivery conduit 548 in communication with the hollow cavity of the barrel 520.

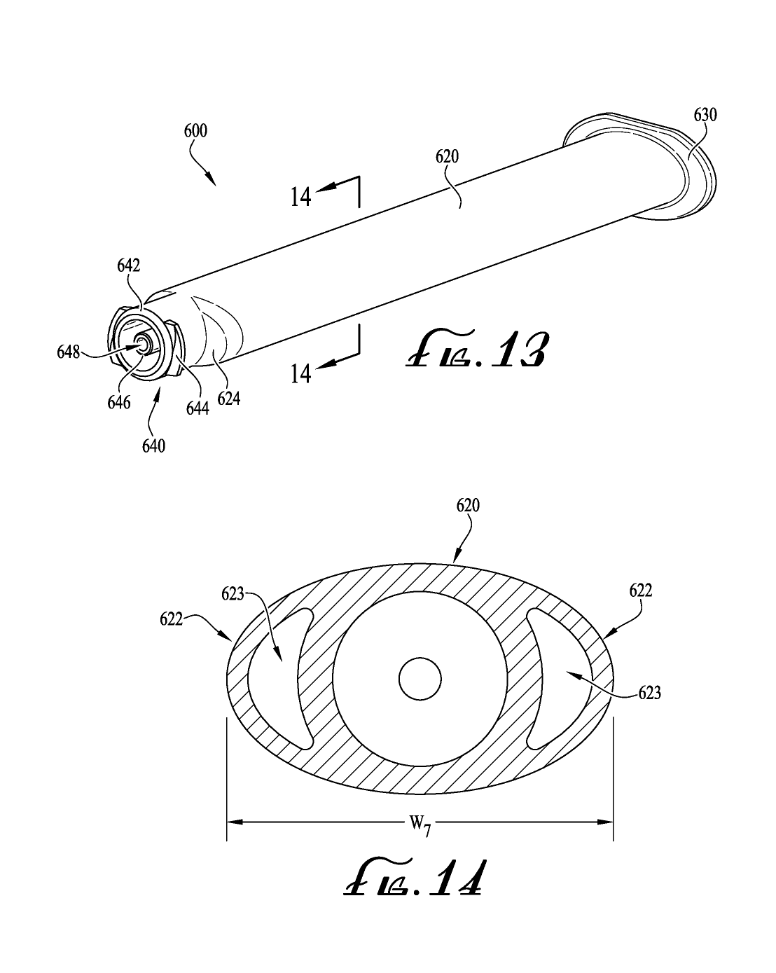

In example embodiments, the barrel 520 is substantially elongate and comprises a generally flat or narrow rectangular cross-sectional shape defining a side-to-side dimension or width W₆ and a thickness T₂ (see FIG. 11). In example embodiments, the width W₆ is at least about 13.3 millimeters and the thickness T₂ can vary as desired, for example, between about 3.5 millimeters to about 12 millimeters, for example about5.5 millimeters according to one example embodiment of the present invention. FIG. 12 shows a generally flat plunger 550 for compatible insertion within the syringe barrel 520 for dispensing or withdrawing fluids from the syringe 500. In example embodiments, the plunger comprises a generally elongate body 552 comprising a forward end portion 554 defining an end portion 556 and an inset extension portion 560 such that a generally recessed channel or groove is defined therein to provide for compatible fitting engagement with a sealing member or gasket. In example embodiments and as depicted in FIG. 11, the plunger 550 is sized and shaped to occupy the substantial entirety of the cavity of the hollow barrel 520, for example, wherein the seal or gasket provides for sealingly engaging the forward end portion 554 of the plunger 550 with the inner surface of the hollow cavity of the barrel 520. Optionally, the rearward end of the plunger 550 can comprise an actuating flange or feature 564 for providing manipulation thereof to push or pull the plunger 550 into and out of the hollow barrel 520.

Referring back to FIG. 10, a pair of corner portions 524 are defined at an end portion of the barrel 520 with the coupling 540 positioned between the corner portions (e.g., generally centrally positioned at a central portion of the end portion) and extending therefrom whereby the fluid delivery conduit 548 extends through the lumen extension tip 546 to within the hollow cavity of the barrel 520. In example embodiments, the cylindrical outer collar extends at least about 6.90 millimeters from the corner portions 524. According to one example embodiment, the cylindrical outer collar extends about 8.52 millimeters from the corner portions 524. Preferably, the corner portions 524 are substantially rounded and radiused to provide a smooth transition to the outer side surfaces of the barrel 520, for example, to eliminate any concern of scratching or causing trauma to a patient's mouth when the coupling 540 (and in some cases a portion of the syringe body 520) is inserted or removed during oral delivery.

FIGS. 13-14 show an enteral syringe 600 according to another example embodiment of the present invention. As depicted, the syringe 600 comprises a hollow barrel 620, a base flange 630 at a distal end of the barrel, and an enteral dosing control coupling 640 at a proximal end of the barrel 620. In example embodiments, enteral dosing control coupling 640 comprises a female ISO 80369-3 formatted coupling having a cylindrical outer collar 642 defining a hollow internal chamber, and a pair of helical coupling lugs 644 projecting outwardly from the exterior surface of the collar. Optionally, rather than lugs 644 projecting from the exterior surface of the collar, the exterior surface of the collar 642 can comprise helical threads generally extending about at least a portion of the exterior surface thereof, for example, like threads on a bolt, other types of conventional coupling members, etc. In some example embodiments, the exterior surface of the collar 642 is entirely smooth without any lugs, for example, whereby a frictional fit will be provided between the collar 642 and a compatible coupling, for example, a male ISO 80369-3 formatted coupling. In example embodiments, the coupling 640 further comprises a lumen extension tip 646 comprising a fluid delivery conduit 648 as described above.

As depicted in FIG. 14, the barrel 620 comprises an elliptical or oval cross-sectional shape comprising a central cylindrical hollow cavity for receiving a plunger and two outer voids or chambers 623. For example, to utilize the central cylindrical hollow chamber for withdrawing or dispensing fluids therefrom by manipulation of the plunger, the outwardly-spaced chambers 623 are configured such that a side-to-side dimension or width W₇ is defined between the outermost surfaces of the barrel 620, or for example, defined between the major axis of the barrel 620. In example embodiments, the width W₇ is at least about 13.3 millimeters. In example embodiments, a pair of corner portions 624 are defined at an end portion of the barrel 620 with the coupling 640 positioned between the corner portions (e.g., generally centrally positioned at a central portion of the end portion) and extending therefrom whereby the fluid delivery conduit 648 extends through the lumen extension tip 646 to within the central cylindrical hollow cavity of the barrel 620. In example embodiments, the cylindrical outer collar extends at least about 6.90 millimeters from the corner portions 624. According to one example embodiment, the cylindrical outer collar extends about 8.52 millimeters from the corner portions 624. Preferably, the corner portions 624 are substantially rounded and radiused to provide a smooth transition to the outer side surfaces of the barrel 620, for example, to eliminate any concern of scratching or causing trauma to a patient's mouth when the coupling 640 (and in some cases a portion of the syringe body 620) is inserted or removed during oral delivery.

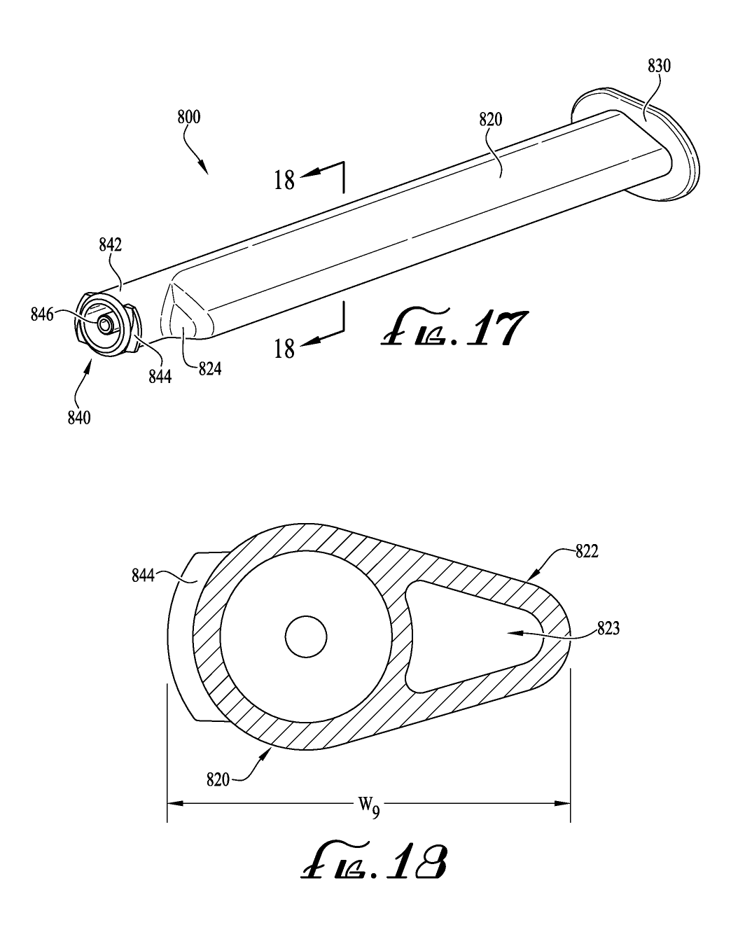

According to additional example embodiments of the present invention, the cross-sectional shape of the syringe barrel can be chosen as desired, for example, such that at least one dimension thereof is at least 13.3 millimeters. For example, FIGS. 15-16 show an enteral syringe 700 comprising a generally rectangular cross-sectional shape comprising a central cylindrical hollow cavity and voids or chambers 723 positioned on opposite sides of the central cylindrical hollow cavity. In example embodiments, the body 700 defines a side-to-side dimension or width W₈ of at least about 13.3 millimeters, for example, taken about sides of the barrel 720 defined between the major axis. In example embodiments, a pair of corner or side portions 724 define an end portion of the barrel 720, for example, wherein the cylindrical outer collar 742 extends therefrom, for example, extending at least about 6.90 millimeters from the side portions 724 according to one example embodiment. Preferably, the corner portions 724 are substantially rounded and radiused to provide a smooth transition to the outer side surfaces of the barrel 720, for example, to eliminate any concern of scratching or causing trauma to a patient's mouth when the coupling 740 (and in some cases a portion of the syringe body 720) is inserted or removed during oral delivery.

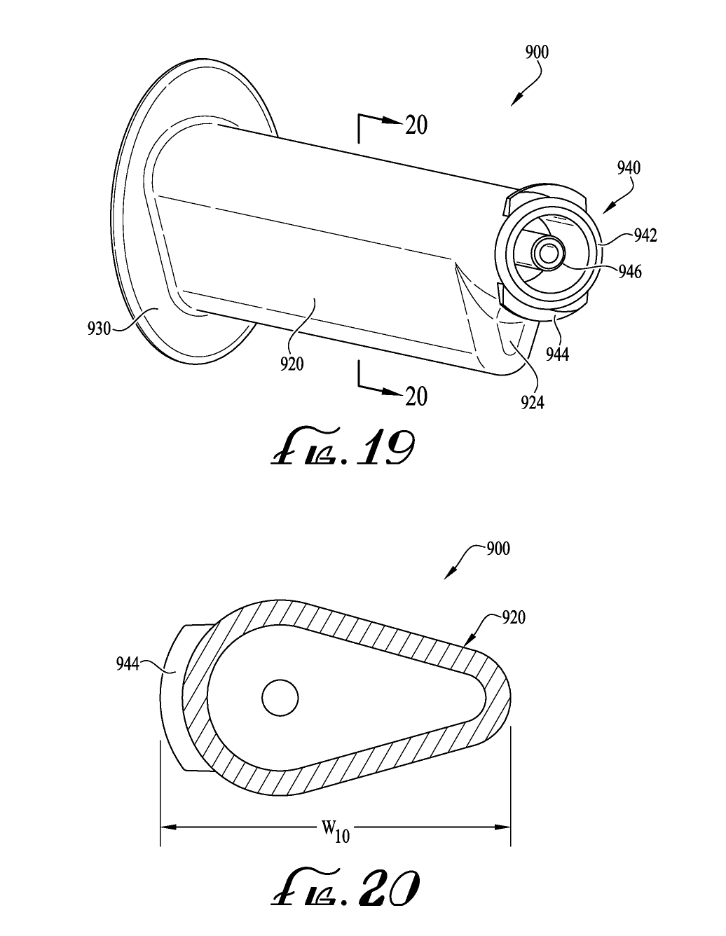

According to another example embodiment, the syringe barrel can comprise other cross-sectional shapes, for example, a teardrop cross-sectional shape as depicted in FIGS. 17-21. In one example embodiment as shown in FIGS. 17-18, the barrel 820 comprises a cylindrical hollow cavity and a chamber 823 offset from the cylindrical hollow cavity wherein a side-to-side dimension or width W₉ is defined along the major axis between an outer surface of a lug 844 and a generally opposite outer periphery portion of the barrel 820. The chamber extends along the side of the cylindrical hollow cavity a majority of the extension of the hollow cavity, and terminates at an end or corner portion 824. In example embodiments, the cylindrical collar 842 is configured to extend at least about 6.90 millimeters from the corner portion 824. According to one example embodiment, the cylindrical outer collar extends about 8.52 millimeters from the corner portion 824. Preferably, the corner portion 824 is substantially rounded and radiused to provide a smooth transition to the outer side surfaces of the barrel 820, for example, to eliminate any concern of scratching or causing trauma to a patient's mouth when the coupling 840 (and in some cases a portion of the syringe body 820) is inserted or removed during oral delivery.

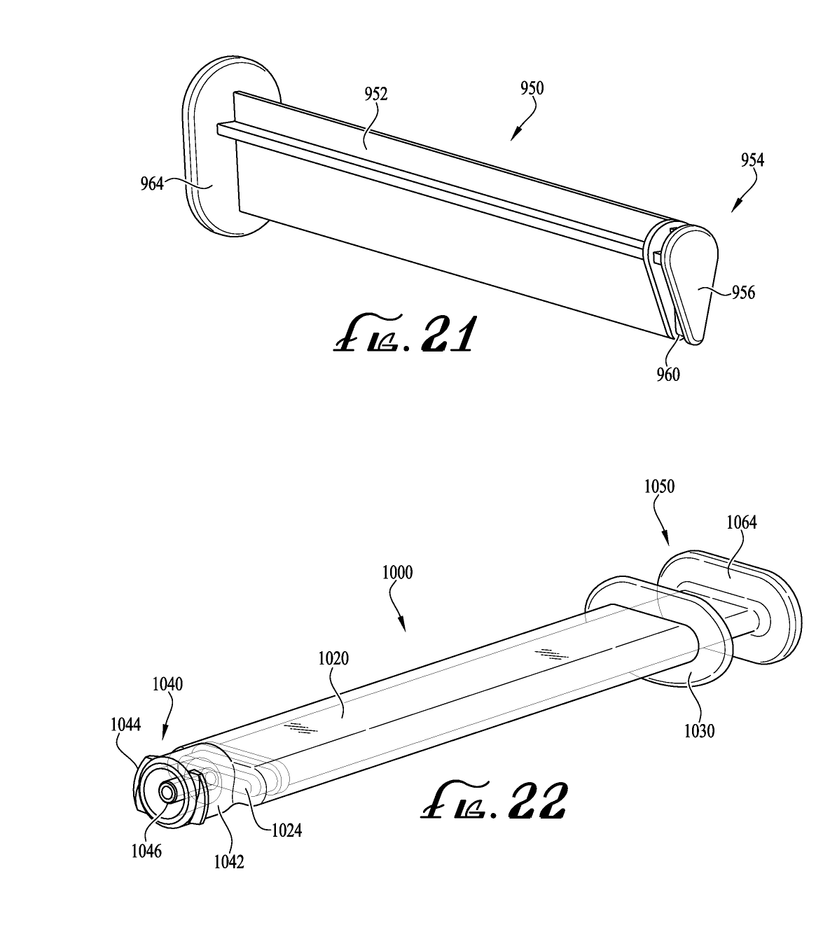

Optionally, according to one example embodiment, rather than the body comprising a cylindrical hollow cavity and a chamber offset therefrom, the entirety of the barrel can comprise a teardrop cross-sectional shape and be substantially hollow therein, for example, to comprise a substantially similar teardrop-shaped hollow cavity. For example, FIGS. 19-20 show an enteral syringe 900 sized and shaped substantially similar to the syringe 800, however, the hollow cavity of the barrel 920 is shaped to have a substantially similar cross-sectional shape, for example, to receiving a complementary teardrop-shaped plunger 950 (see FIG. 21). In example embodiments, a side-to-side dimension or width W₁₀ is defined along the major axis of the teardrop cross-sectional shape of the barrel 920 between an outer surface of a lug 944 and a generally opposite outer periphery portion of the barrel 920 (see FIG. 20). The chamber extends along the side of the cylindrical hollow cavity a majority of the extension of the hollow cavity, and terminates at an end or corner portion 924. In example embodiments, the cylindrical collar 942 is configured to extend at least about 6.90 millimeters from the corner portion 924. According to one example embodiment, the cylindrical outer collar extends about 8.52 millimeters from the corner portion 924. Preferably, the corner portion 924 is substantially rounded and radiused to provide a smooth transition to the outer side surfaces of the barrel 920, for example, to eliminate any concern of scratching or causing trauma to a patient's mouth when the coupling 940 (and in some cases a portion of the syringe body 920) is inserted or removed during oral delivery.

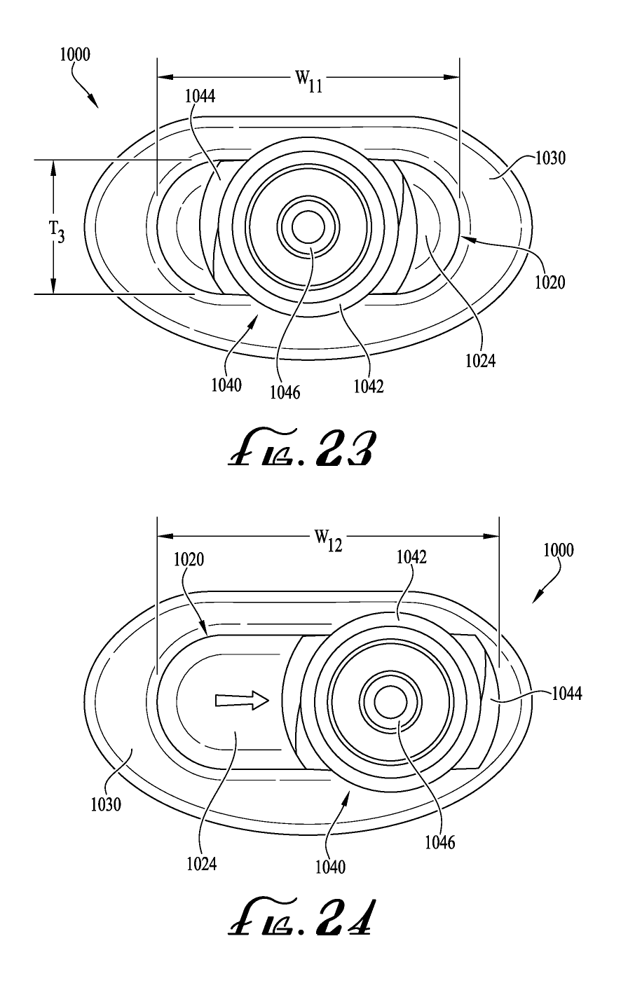

FIGS. 22-23 show an enteral syringe 1000 according to another example embodiment of the present invention. In example embodiments, the syringe 1000 is substantially similar to the syringe 500 as described above, for example, comprising a hollow and generally flat barrel 1020, a base flange 1030 at a distal end of the barrel 1020, and an enteral dosing control coupling 1040 at a proximal end of the barrel 1020. In example embodiments, enteral dosing control coupling 1040 comprises a female ISO 80369-3 formatted coupling having a cylindrical outer collar 1042 defining a hollow internal chamber, and a pair of helical coupling lugs 1044 projecting outwardly from the exterior surface of the collar. Optionally, rather than lugs 1044 projecting from the exterior surface of the collar, the exterior surface of the collar 1042 can comprise helical threads generally extending about at least a portion of the exterior surface thereof, for example, like threads on a bolt, other types of conventional coupling members, etc. In some example embodiments, the exterior surface of the collar 1042 is entirely smooth without any lugs, for example, whereby a frictional fit will be provided between the collar 1042 and a compatible coupling, for example, a male ISO 80369-3 formatted coupling. In example embodiments, the coupling 1040 further comprises a lumen extension tip 1046 comprising a fluid delivery conduit in communication with the hollow cavity of the barrel 1020.

In example embodiments the barrel 1020 is substantially elongate and comprises a generally flat or narrow rectangular cross-sectional shape defining a side-to-side dimension or width W₁₁ and a thickness T₃ (see FIG. 23). In example embodiments, the width W₁₁ is at least about 13.3 millimeters and the thickness T₃ can vary as desired, for example, between about 3.5 millimeters to about 12 millimeters, for example about 6.5 millimeters according to one example embodiment of the present invention. A generally flat plunger 1050 can be provided for compatible insertion within the syringe barrel 1020 for dispensing or withdrawing fluids from the syringe 1000. In example embodiments, the plunger comprises a generally elongate body comprising a forward end portion defining an end portion and an inset extension portion such that a generally recessed channel or groove is defined therein to provide for compatible fitting engagement with a sealing member or gasket. In example embodiments, the plunger 1050 is sized and shaped to occupy the entirety of the cavity of the hollow barrel 1020, for example, wherein the seal or gasket provides for sealingly engaging the forward end portion of the plunger 1050 with the inner surface of the hollow cavity of the barrel 1020. Optionally, the rearward end of the plunger 1050 can comprise an actuating flange or feature 1064 for providing manipulation thereof to push or pull the plunger 1050 into and out of the hollow barrel 1020.

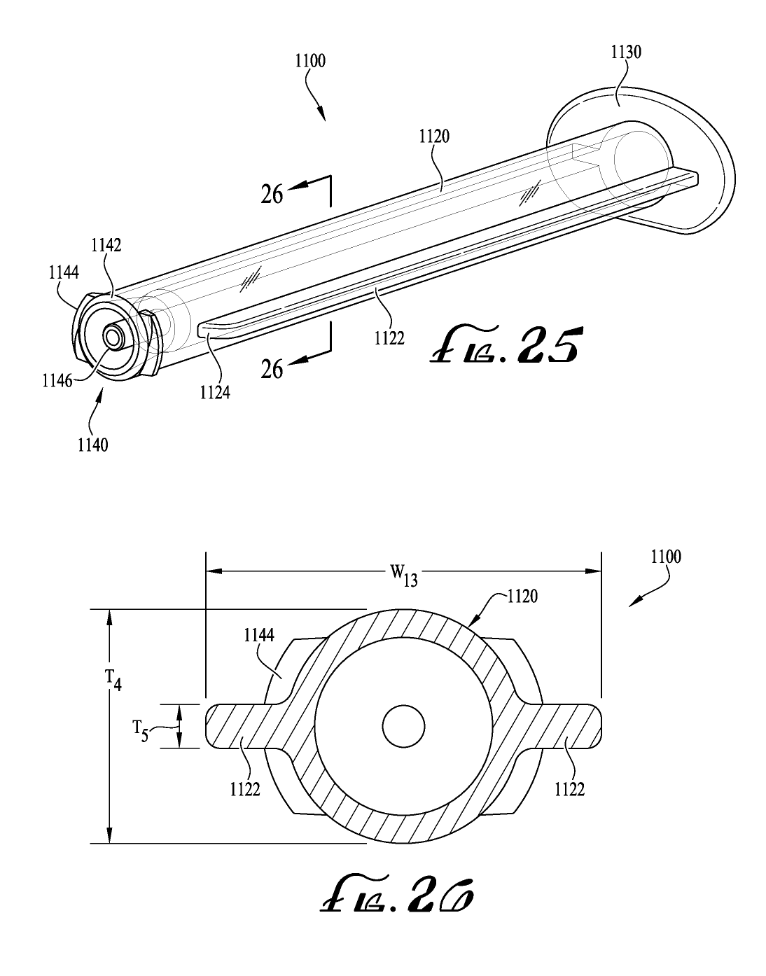

In example embodiments, a pair of corner portions 1024 are defined at an end portion of the barrel 1020 with the coupling 1040 positioned between the corner portions (e.g., generally centrally positioned at a central portion of the end portion) and extending therefrom whereby the fluid delivery conduit 1048 extends through the lumen extension tip 1046 to within the hollow cavity of the barrel 1020. In example embodiments, the cylindrical outer collar extends at least about 6.90 millimeters from the corner portions 1024. According to one example embodiment, the cylindrical outer collar extends about 8.52 millimeters from the corner portions 1024. Preferably, the corner portions 1024 are substantially rounded and radiused to provide a smooth transition to the outer side surfaces of the barrel 1020, for example, to eliminate any concern of scratching or causing trauma to a patient's mouth when the coupling 1040 (and in some cases a portion of the syringe body 1020) is inserted or removed during oral delivery. In example embodiments, and in comparison to the syringe 500, the thickness T₃ is greater than the thickness T₂, and thus, a more subtle or reduced transition is provided between the outer surfaces of the barrel 1020 and the outer cylindrical collar 1042. According to one example embodiment, the coupling 1040 can be positioned entirely to one side of the barrel 1020, for example, as depicted in FIG. 24. As shown, a side-to-side dimension or width W₁₂ is defined between an outer periphery surface of the barrel 1020 and a lug 1044.

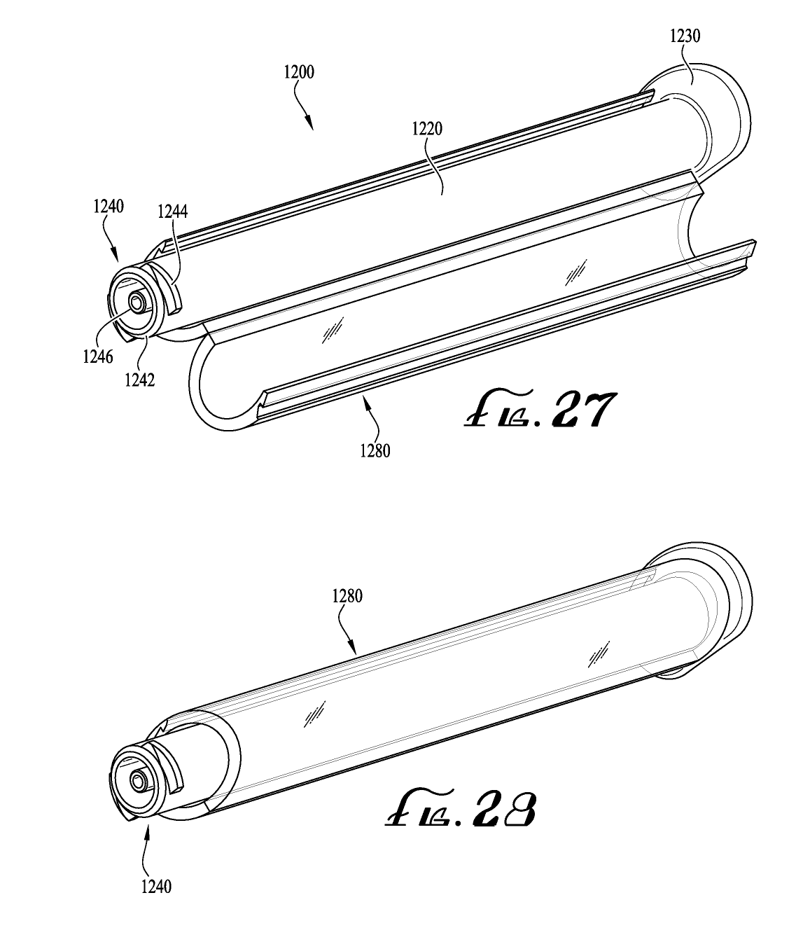

FIGS. 25-26 show an enteral syringe 1100 according to another example embodiment of the present invention. As depicted, the syringe 1100 comprises a hollow cylindrical barrel 1120 comprising a pair of fins 1122 oppositely and outwardly extending therefrom along the extension of the cylindrical barrel 1120, a base flange 1130 at a distal end of the barrel, and an enteral dosing control coupling 1140 at a proximal end of the barrel 1120. In example embodiments, enteral dosing control coupling 1140 comprises a female ISO 80369-3 formatted coupling having a cylindrical outer collar 1142 defining a hollow internal chamber, and a pair of helical coupling lugs 1144 projecting outwardly from the exterior surface of the collar. Optionally, rather than lugs 1144 projecting from the exterior surface of the collar, the exterior surface of the collar 1142 can comprise helical threads generally extending about at least a portion of the exterior surface thereof, for example, like threads on a bolt, other types of conventional coupling members, etc. In some example embodiments, the exterior surface of the collar 1142 is entirely smooth without any lugs, for example, whereby a frictional fit will be provided between the collar 1142 and a compatible coupling, for example, a male ISO 80369-3 formatted coupling. In example embodiments, the coupling 1140 further comprises a lumen extension tip 1146 comprising a fluid delivery conduit as described above.

As depicted in FIG. 26, the fins 1122 generally extend on opposite sides of the barrel 1120 from the base flange 1130 and terminate at least about 6.90 millimeters from the end of the coupling 1140. According to one example embodiment, the fins 1122 are configured such that they terminate at least about 7 millimeters from an end portion of the coupling 1140, for example, about 8.52 millimeters according to one example embodiment of the present invention. Preferably, the terminated ends of the fins near the coupling 1140 are substantially rounded and radiused to eliminate any concern of scratching or causing trauma to a patient's mouth when the coupling 1140 (and in some cases a portion of the syringe body 1120) is inserted or removed during oral delivery. In example embodiments, a side-to-side dimension or width W₁₃ is defined between the outermost ends or surfaces of the fins 1122, for example, which is generally at least about 13.3 millimeters. In example embodiments, the syringe barrel 1120 is substantially uniform along the entirety of the barrel, for example, such that a diameter or thickness T₄ is between about 8.00-8.20 millimeters, for example about 8.10 millimeters according to one example embodiment. According to example embodiments, the fins 1122 define a thickness T₅ of between about 0.50-4 millimeters, for example about 2 millimeters according to one example embodiment.

FIGS. 27-29 show an enteral syringe 1200 according to another example embodiment of the present invention. As depicted, the syringe 1200 comprises an elongate hollow cylindrical barrel 1220, a base flange 1230 at a distal end of the barrel, an enteral dosing control coupling 1240 at a proximal end of the barrel 1220, and a sleeve member 1280 removably mounted to the barrel 1220. In example embodiments, enteral dosing control coupling 1240 comprises a female ISO 80369-3 formatted coupling having a cylindrical outer collar 1242 defining a hollow internal chamber, and a pair of helical coupling lugs 1244 projecting outwardly from the exterior surface of the collar. Optionally, rather than lugs 1244 projecting from the exterior surface of the collar, the exterior surface of the collar 1242 can comprise helical threads generally extending about at least a portion of the exterior surface thereof, for example, like threads on a bolt, other types of conventional coupling members, etc. In some example embodiments, the exterior surface of the collar 1242 is entirely smooth without any lugs, for example, whereby a frictional fit will be provided between the collar 1242 and a compatible coupling, for example, a male ISO 80369-3 formatted coupling. In example embodiments, the coupling 1240 further comprises a lumen extension tip 1246 comprising a fluid delivery conduit as described above.

The sleeve member 1280 is removably mounted to the barrel 1220 of the syringe 1200, for example, wherein a first part 1282 and a second part 1284 are pivotally coupled to each other by a living hinge 1286, and wherein end engagement portions 1283, 1285 interengage with each other such that the sleeve member 1280 remains engaged with the syringe barrel 1220. For example, according to example embodiments of the present invention, the sleeve member 1280 is generally elliptical or oval when assembled and viewing an end thereof (see FIG. 29). Thus, according to example embodiments of the present invention, the sleeve member 1280 defines a side-to-side dimension or width W₁₄ taken along the major axis of the elliptical shape. As depicted in FIG. 29, the sleeve 1280 is preferably dimensioned in its minor axis such that an interference fit is provided when the engagement portions 1283, 1285 engage or removably lock with each other. Optionally, one or more portions of the syringe could comprises engagement portions for complementary engagement portions of the sleeve, for example, in a case where no interference existed between the sleeve and the inner surface of the sleeve, whereby one or more complementary engagement features could be provided to facilitate engagement of the sleeve member 1280 with the syringe barrel 1220. According to one example embodiment, an end of the sleeve that is generally near the coupling can preferably be substantially rounded or comprise a substantially gradual and smooth transition, for example, to eliminate any concern of the end of the sleeve scratching or causing trauma to a patient's mouth when the coupling (and in some cases a portion of the syringe body) is inserted or removed during oral delivery.

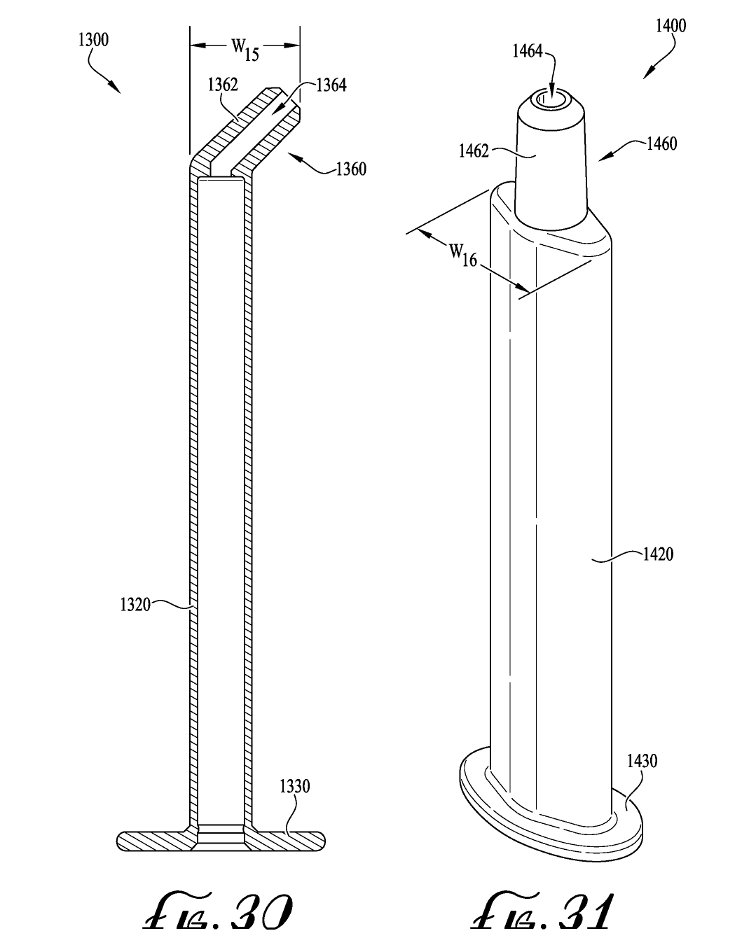

FIGS. 30-31 show enteral syringes 1300, 1400 according to additional example embodiments of the present invention. In example embodiments, the syringes 1300, 1400 are substantially similar to the syringes as described above, however, the female ISO 80369-3 formatted coupling is replaced with a male ISO 80369-3 formatted coupling. U.S. Non-Provisional patent application Ser. No. 15/659,323 filed Jul. 25, 2017 is incorporated herein by reference in its entirety and shows an enteral syringe having a male ISO 80369-3 formatted coupling. In example embodiments, the syringe 1300 comprises a cylindrical barrel 1320 comprising a base flange 1330 at a distal end of the barrel 1320, and a male ISO 80369-3 formatted coupling 1360 at the proximal end of the barrel and extending relative to the barrel 1320 at an angle. In example embodiments, the coupling 1360 comprises a cylindrical member 1362 defining a lumen 1364 extending entirely therethrough and in communication with the hollow cylindrical barrel 1320. In example embodiments, a side-to-side dimension or width W₁₅ is defined between an outer periphery portion of the barrel 1320 and an opposite outermost portion of the male coupling 1360. According to one example embodiment, the male coupling 1360 extends at about 45 degrees relative to the extension of the barrel 1320. Optionally, as depicted in FIG. 31, the male coupling 1460 is positioned atop an end of a diamond-shaped barrel 1420, for example, wherein a side-to-side dimension or width W₁₆ is at least about 13.3 millimeters. Optionally, other barrels of other cross-sectional shapes can comprise a male ISO 80369-3 coupling as described herein, for example, wherein at least one side-to-side dimension of the syringe is at least about 13.3 millimeters.

Example embodiments of the present invention preferably provide a side-to-side dimension of at least about 13.3 millimeters, for example, to maintain compliance or compatibility with the ISO 80369-3 design standard. Preferably, various other components or features can be provided with the enteral syringes as described herein as desired, for example, to maintain compliance or compatibility with the ISO 80369-3 standard whereby a side-to-side dimension of the enteral syringe is at least about 13.3 millimeters. As described above, the dosing control coupling can be angled relative to the barrel such that the side-to-side dimension is at least about 13.3 millimeters. Furthermore, as similarly described above, the syringe barrel can comprise a desired cross-sectional shape such that a side-to-side dimension thereof is at least about 13.3 millimeters. In example embodiments, the enteral dosing control coupling as described herein generally extends between about 6.9 millimeters to about 11.00 millimeters (e.g., see L1 of FIG. 1) from the portion of the syringe defining the side-to-side dimension of at least 13.3 millimeters. In example embodiments, the dosing control coupling as described above can be configured such that the exterior surface of the collar comprises helical threads generally extending about at least a portion of the exterior surface thereof, for example, like threads on a bolt, other types of conventional coupling members, etc. In some example embodiments, the threads are fully concentric, for example, extending substantially about the entire periphery of the cylindrical collar along a helical path. In some example embodiments, the exterior surface of the collar is entirely smooth without any lugs, for example, whereby a frictional fit will be provided between the collar and a compatible coupling, for example, a male ISO 80369-3 formatted coupling.

According to some example embodiments of the present invention, the various plungers for operation with the syringes as described above can comprise a tip extension or forward body portion for extending within the internal lumen of the lumen extension tip, for example, to further eliminate the dead space within the internal lumen of the lumen extension tip to that dosing inconsistencies and anomalies in accuracy during fluid delivery are further reduced, minimized or substantially, if not entirely, eliminated. U.S. Non-Provisional patent application Ser. No. 15/210,282 filed Jul. 14, 2016 is incorporated herein by reference in its entirety and shows an enteral syringe having a dosing control coupling comprising a lumen extension tip and a plunger comprising a tip or rod for extension within an internal lumen of the lumen extension tip.

According to example embodiments, a substantially rounded or radiused transition is provided near the connection of the coupling with the barrel (e.g., outer side surfaces of the barrel or other features or their corresponding terminating ends generally near the coupling) or other portions of the syringe defining the side-to-side dimension of at least 13.3 millimeters, for example, to eliminate any concern of scratching or causing trauma to a patient's mouth when the coupling (and in some cases a portion of the syringe body) is inserted or removed during oral delivery.

What is claimed is:

1. An enteral syringe comprising a hollow cylindrical barrel extending between a proximal end and a distal end, a base flange at a distal end of the barrel, and an enteral dosing control coupling at a proximal end of the barrel, the enteral dosing control coupling being angled relative to the extension of the hollow cylindrical barrel such that a side-to-side dimension of at least about 13.3 millimeters is defined between an outer surface of the barrel and an outermost end of the dosing control coupling.

2. The enteral syringe of claim 1, wherein the dosing control coupling comprises a female ISO 80369-3 formatted coupling.

3. The enteral syringe of claim 2, wherein the female ISO 80369-3 formatted coupling comprises a cylindrical outer collar defining a hollow internal chamber.

4. The enteral syringe of claim 3, further comprising a lumen extension tip projecting axially from the barrel and within the internal chamber of the female ISO 80369-3 formatted coupling, the lumen extension tip comprising a small diameter lumen extending therethrough and in communication with the hollow cylindrical barrel.

5. The enteral syringe of claim 3, further comprising a pair of helical coupling lugs projecting outwardly from an exterior surface of the collar.

6. The enteral syringe of claim 1, wherein the dosing control coupling comprises a male ISO 80369-3 formatted coupling.

7. The enteral syringe of claim 1, wherein the dosing control coupling is angled between about 90-165 degrees relative to the hollow cylindrical barrel.

8. The enteral syringe of claim 5, wherein the side-to-side dimension is defined between an outer surface of the barrel and an outermost surface of one of the coupling lugs.

9. An enteral syringe comprising an elongate barrel comprising a proximal end and a distal end, and a hollow cavity defined therein, the proximal end comprising an enteral dosing control coupling and the distal end comprising a base flange, the elongate barrel comprising a cross-sectional shape defining a side-to-side dimension of at least about 13.3 millimeters.

10. The enteral syringe of claim 9, wherein the dosing control coupling comprises a female ISO 80369-3 formatted coupling.

11. The enteral syringe of claim 10, wherein the female ISO 80369-3 formatted coupling comprises a cylindrical outer collar defining a hollow internal chamber.

12. The enteral syringe of claim 11, further comprising a lumen extension tip projecting axially from the barrel and within the internal chamber of the female ISO 80369-3 formatted coupling, the lumen extension tip comprising a small diameter lumen extending therethrough and in communication with the hollow cavity of the elongate barrel.

13. The enteral syringe of claim 9, wherein the dosing control coupling comprises a male ISO 80369-3 formatted coupling.

14. The enteral syringe of claim 9, wherein the elongate barrel comprises a diamond-shaped cross-sectional shape and the side-to-side dimension is defined between the outermost peripheral surfaces of the barrel taken along a major axis thereof.

15. The enteral syringe of claim 9, wherein the elongate barrel comprises a generally flat and rectangular cross-sectional shape and the side-to-side dimension is defined between the outermost peripheral surfaces of the barrel taken along a major axis thereof.

16. The enteral syringe of claim 9, wherein the elongate barrel comprises an elliptical cross-sectional shape and the side-to-side dimension is defined between the outermost peripheral surfaces of the barrel taken along a major axis thereof.

17. The enteral syringe of claim 9, wherein the elongate barrel comprises a rectangular cross-sectional shape and the side-to-side dimension is defined between the outermost peripheral surfaces of the barrel taken along a major axis thereof.

18. The enteral syringe of claim 9, wherein the elongate barrel comprises a teardrop cross-sectional shape and the side-to-side dimension is defined between the outermost peripheral surfaces of the barrel taken along a major axis thereof.

19. An enteral syringe comprising an elongate cylindrical barrel extending between a proximal end and a distal end and defining a hollow cavity therein, the proximal end comprising an enteral dosing control coupling and the distal end comprising a base flange, and further comprising one or more features extending outwardly from the elongate cylindrical barrel such that a side-to-side dimension between the one or more outwardly extending features is at least about 13.3 millimeters.

20. The enteral syringe of claim 19, wherein the one or more features comprise a pair of fins oppositely positioned and outwardly extending from the elongate cylindrical barrel, wherein the side-to-side dimension defined between the outermost ends of the fins is at least about 13.3 millimeters.

21. The enteral syringe of claim 19, wherein the one or more features comprise a removable sleeve member for coupling around the entirety of the elongate cylindrical barrel, wherein the side-to-side dimension defined between the outermost surfaces of the sleeve is at least about 13.3 millimeters.

22. The enteral syringe of claim 10, wherein the sleeve comprises a first part and a second part pivotally coupled together by a living hinge, and wherein end engagement portions of the first and second parts are configured for removable engagement therebetween such that the sleeve can entirely surround the elongate cylindrical barrel and provide at least some interference therewith.
